(19) United States
(12) Patent Application Publication
(10) Pub. No.: US 2014/0353327 A1
(43) Pub. Date: Dec. 4, 2014

(54) ATYPICAL PILL DISPENSING APPARATUS

(71) Applicant: INFOPIA Co., Ltd., Anyang-si (KR)

(72) Inventors: Byeong-Woo Bae, Anyang-si (KR); Keun-Young Kim, Seoul (KR)

(73) Assignee: INFOPIA CO., LTD., Anyang-si (KR)

(21) Appl. No.: 14/291,617

(22) Filed: May 30, 2014

(30) Foreign Application Priority Data
May 31, 2013 (KR) 10-2013-0062860

(51) Int. Cl. A61J 7/02; A61J 7/00; B65D 83/04

(52) U.S. Cl. CPC A61J 7/02; B65D 83/04; A61J 7/0076
USPC 221/7; 221/12; 221/13

(57) ABSTRACT

An atypical pill dispensing apparatus. The atypical pill dispensing apparatus may include a pill depository, a pill transporter, and a controller. The pill depository accommodates atypical pills. The pill transporter includes: a housing including an inlet opening formed on one side to be provided with the atypical pills from the pill depository, and a discharging opening formed on the other side to discharge the atypical pills; a screw with one end disposed corresponding to the inlet opening and the other end disposed corresponding to the discharging opening so as to transport the atypical pills along a spiral when rotating; and a screw driver to rotate the screw. The controller enables the pill transporter to control the transportation of the atypical pills.

### CROSS-REFERENCE TO RELATED APPLICATION(S)

This application claims the benefit under 35 U.S.C. §119(a) of Korean Patent Application No. 10-2013-0062860, filed on May 31, 2013, in the Korean Intellectual Property Office, the entire disclosure of which is incorporated herein by reference for all purposes.

### BACKGROUND

1. Field

The following description relates to an atypical pill dispensing apparatus to dispense atypical pills by being adopted to a medication packaging apparatus.

2. Description of the Related Art

In order to solve a problem of pharmacist manually dispensing medication, a medication dispensing apparatus is provided. In general, the medication dispensing apparatus has multiple pill cartridges, which are arranged in multiple layers at an upper portion to contain various types of pills. The pills contained in the pill cartridges may be selectively discharged under the user's control by use of a computer, and the pills discharged from the pill cartridges are collected in a hopper and then packaged in a packaging unit located in a lower portion of the medication dispensing apparatus. The prior art related to the medication dispensing apparatus is Korean Patent Registration No. 10-1025117 (published on Apr. 1, 2004).

Due to the development of new medications, atypical pills of different shapes from a general shape, or atypical pills split in halves or in several pieces may be dispensed. However, the conventional medication packaging apparatus has problems of being time consuming in setting the initial setting, such as for replacement of a pill cartridge suitable for atypical pills.

In another example, a semi-automatic dispensing method may be provided to help pills with a general shape to be dispensed together with the atypical pills by manually inserting the atypical pills one by one into the medication packaging apparatus by a preparator. However, the semi-automatic dispensing method may have problems of causing a time delay in dispensing the medication, or missing or exceeding the medication through errors of a preparator, which may reduce the reliability.

### SUMMARY

The following description aims to provide an atypical pill dispensing apparatus that is capable of quick, precise, and automatic dispensation of various types of atypical pills.

In one general aspect, the atypical pill dispensing apparatus includes a pill depository, a pill transporter, and a controller. The pill depository contains typical pills. The pill transporter includes: a housing including an inlet opening formed on one side to be provided with the atypical pills from the pill depository, and a discharging opening formed on the other side to discharge the atypical pills; a screw with one end disposed corresponding to the inlet opening and the other end disposed corresponding to the discharging opening so as to transport the atypical pills along a spiral when rotating; and a screw driver to rotate the screw. The controller enables the pill transporter to control a transportation of the atypical pills on the basis of the information detected by the pill detector.

In another general aspect, the atypical pill dispensing apparatus includes a pill depository, a pill transporter, and a controller. The pill depository contains atypical pills. The pill transporter includes: a housing including an inlet opening formed on one side to be provided with the atypical pills from the pill depository, and a discharging opening formed on the other side to discharge the atypical pills; a first transporting member including, in the housing, a first shaft with one end disposed corresponding to the inlet opening and the other end disposed corresponding to the discharging opening, and a first spiral projection protruding in a spiral form along a circumference of the first shaft; a second transporting member including, in the housing, a second shaft with one end disposed corresponding to the inlet opening and the other end disposed corresponding to the discharging opening, wherein the second shaft is disposed in parallel to the first shaft, and a second spiral projection protruding in a spiral form along a circumference of the second shaft; and a transporting member driver to transport the atypical pills accommodated in limited space generated by the first and second spiral projections in response to rotation of the first and second transporting members simultaneously and symmetrically in opposing directions. The controller enables the pill transporter to control a transportation of the atypical pills.

Other features and aspects may be apparent from the following detailed description, the drawings, and the claims.

### BRIEF DESCRIPTION OF THE DRAWINGS

FIG. 1 is a diagram illustrating an example of an atypical pill dispensing apparatus according to an exemplary embodiment.

FIG. 2 is a diagram illustrating an example of an operation of a pill transporter of FIG. 1.

FIG. 3 is a perspective view illustrating an example of a shooter.

FIG. 4 is a diagram illustrating an example of a shooter of FIG. 3 with first and second stoppers.

FIG. 5 is a diagram illustrating an example of an operation of first and second stoppers of FIG. 4.

FIG. 6 is a perspective view of another example of a pill transporter of FIG. 1.

FIG. 7 is a diagram illustrating an example of a hopper unit to which an atypical pill is provided from a shooter of FIG. 1.

FIGS. 8 and 9 are diagrams illustrating examples of operations of a hopper unit of FIG. 7.

FIG. 10 is a diagram illustrating another example of a separation plate of FIG. 7.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

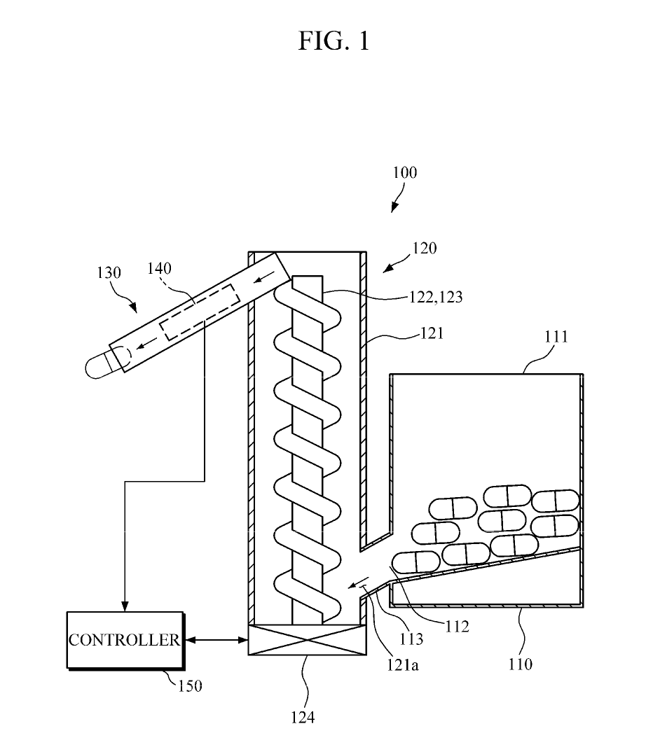

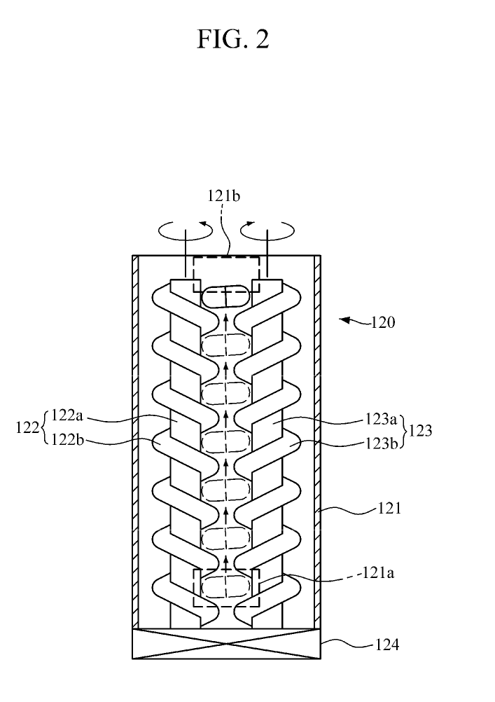

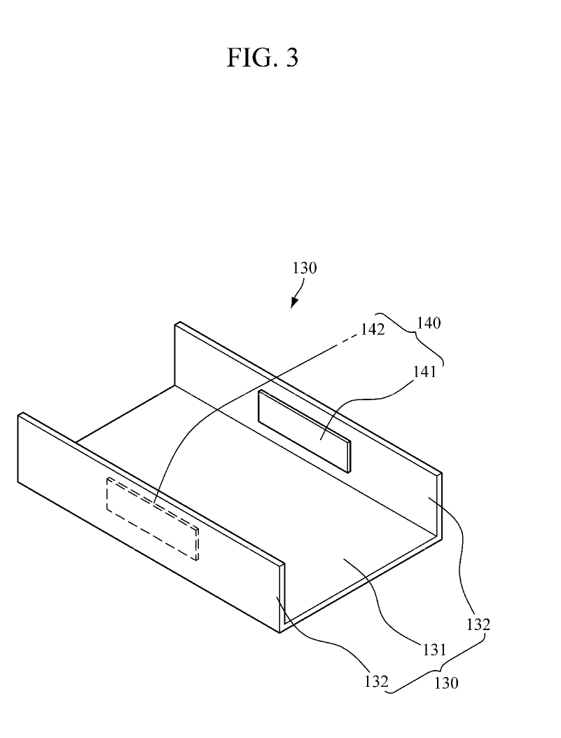

FIG. 1 is a diagram illustrating an example of an atypical pill dispensing apparatus according to an exemplary embodiment. FIG. 2 is a diagram illustrating an example of an operation of a pill transporter of FIG. 1. FIG. 3 is a perspective view illustrating an example of a shooter.

Referring to FIGS. 1 to 3, an atypical pill dispensing apparatus 100 includes a pill depository 110, a pill transporter 120, a shooter 130, a pill detector 140, and a controller 150.

The pill depository 110 contains atypical pills. The atypical pill may have a different shape from a general shape of a pill, or be in shapes of pills that are split in halves or in several pieces. The pill depository 110 may contain the same types of atypical pills. The pill depository 110 may provide the contained atypical pills to the pill transporter 120. For example, the pill depository 110 may have an inner space, a depository opening 111 at an upper portion, and an outlet opening 112 at a lower portion. The outlet opening 112 of the pill depository 110 may be formed to be positioned higher than an inlet opening 121a of the pill transporter 120 and be open to a channel 113. With the outlet opening 112 positioned higher than the inlet opening 121a, the atypical pill may fall from the outlet opening 112 of the pill depository 110, passing through the channel 113, and be provided for the inlet opening 121a of the pill transporter 120.

The pill transporter 120 may be provided with the atypical pills from the pill depository 110, and transport the atypical pills to the shooter 130. For example, the pill transporter 120 may include a housing 121, first and second transporting members 122 and 123, and a transporting member driver 124. The housing 121 may have an inner space. The housing 121 may include the inlet opening 121a formed on one side to be provided with the atypical pills from the pill depository 110, and a discharging opening 121b to discharge the atypical pills to the other side. The housing 121 may include the discharging opening 121b disposed in a vertical position higher than the inlet opening 121a. In another example not illustrated in FIGS. 1, 2, and 3, the housing may include the discharging opening disposed to be inclined at a higher position than the inlet opening. Also, the housing may include the inlet opening disposed in a vertical or inclined direction at a higher position than the discharging opening.

The first transporting member 122 may be equipped with a first shaft 122a and a first spiral projection 122b. The first shaft 122a may include, inside the housing 121, one end disposed corresponding to the inlet opening 121a and the other end disposed corresponding to the discharging opening 121b. The first spiral projection 122b may protrude in a spiral form along the circumference of the first shaft 122a. The second transporting member 123 may be equipped with a second shaft 123a and a second spiral projection 123b. The second shaft 123a may be disposed in parallel to the first shaft 122a inside the housing 121. The second shaft 123a may include one end disposed corresponding to the inlet opening 121a and the other side disposed corresponding to the discharging opening 121b. The second spiral projection 123b may protrude in a spiral form along the circumference of the second shaft 123a.

The first and second spiral projections 122b and 123b may accommodate the atypical pill in limited space. The first and second spiral projections 122b and 123b may be implemented with a wire member that is wound and fixed in a spiral form along each circumference of the first and second shafts 122a and 123a. Also, the first and second spiral projections 122b and 123b may be formed in one body with the first and second shafts 122a and 123a.

By rotating the first and second transporting members 122 and 123 simultaneously and symmetrically in opposing directions, the transporting member driver 124 may transport the atypical pill accommodated in the limited space generated by the first and second spiral projections 122b and 123b. In other words, the atypical pill may be accommodated in the limited space from the side of the inlet opening 121a of the housing 121 by the first and second spiral projections 122b and 123b. Then, when the first and second spiral projections 122b and 123b rotate in opposing directions to each other, the atypical pill may be transported along axes of the first and second shafts 122a and 123a to be thereby discharged through the discharging opening 121b of the housing 121.

For example, the transporting member driver 124 may include a rotating motor and a power transferring means that transfers the rotatory power of the rotating motor to the first and second shafts 122a and 123a. The power transferring means may include pulleys that are fixed to the rotating axis of the rotating motor and the first and second shafts 122a and 123a in the same axis, and belts that are hung to the pulleys. The power transferring means may be also provided in various ways not limited to the example mentioned above. Moreover, the transporting member driver 124 may include the rotating motors, each of which rotates the respective first and second transporting members 122 and 123.

In addition, the space of the first and second transporting members 122 and 123 may be changed according to a shape and size of an atypical pill. The illustration herein shows the first and second transporting members 122 and 123 transporting a capsule-shaped atypical pill; however, various shapes of atypical pills may be transported, such as a disc shape, a heart shape, a lens shape, etc.

The shooter 130 may drop the transported atypical pill, which was provided by the pill transporter 120, at an angle. The shooter 130 may include: a sloping plate 131 supporting the atypical pill placed thereon; and supporting plates 132 that support both sides of the atypical pill by standing on both sides of the sloping plate 131. The sloping plate 131 may be disposed to be inclined downward from the discharging opening 121b of the housing 121. Thus, the sloping plate 131 may allow the atypical pill to be dropped at an angle along its sloping plate 131.

The pill detector 140 may be installed to detect information on the atypical pill entering into the inside of the shooter 130. For example, the pill detector 140 may include a light emitter 141 to send the light, and a light receiver 142 to receive the light. The light emitter 141 and the light receiver 142 may be respectively disposed on the sides of the supporting plates 132, wherein the sides face each other. The light emitter 141 may be formed in an array, which is arranged on one side of the supporting plate 132 along the sloping plate 131 in an inclined direction; and the light receiver 142 may also be formed in an array corresponding to each light emitting part of the light emitters 141. The pill detector 140 may detect information of a shape, size, amount, and the like, of the atypical pills passing through the shooter 130, and provide the detected information to the controller 140.

The controller 150 may enable the pill transporter 120 to control the transportation of the atypical pill on the basis of the information detected by the pill detector 140. For example, the controller 150 may determine a type of atypical pill based on the shape and size information from the pill detector 140 on the first atypical pill passing through the shooter 130. Then, by the transporting member driver 124 adjusting a transportation gap of the atypical pill according to the determination of the type of atypical pill, the controller 150 may provide the atypical pill one by one to the shooter 130 through the discharging opening 121b of the housing 121.

The controller 150 may count an amount of atypical pills passing through the shooter 130 on the basis of the information of the atypical pill provided from the pill detector 140. Also, the controller 150 may determine whether two or more atypical pills have been discharged at one time through the shooter 130 on the basis of the information of the atypical pill provided from the pill detector 140. In a case in which the controller 150 determines that the atypical pills have been discharged at the same time through the shooter 130, the atypical pills discharged together may be collected by a hopper unit 160, which will be described later.

By the above-mentioned atypical pill dispensing apparatus 100, various types of atypical pills may be automatically dispensed even though prescriptions include pills of different shapes from a general shape, which is caused by a development of new medications, or pills split in halves or in several pieces. Thus, according to the exemplary embodiments, in contrast to the related art, quickly dispensing pills may be executed without an initial setting, such as a replacement of a pill cartridge suitable for atypical pills. In addition, the exemplary embodiments may shorten time for dispensing pills by not manually but automatically dispensing pills, and also may avoid problems of missing or exceeding the medication through errors of a preparator. As a result, reliability for dispensing pills may become higher.

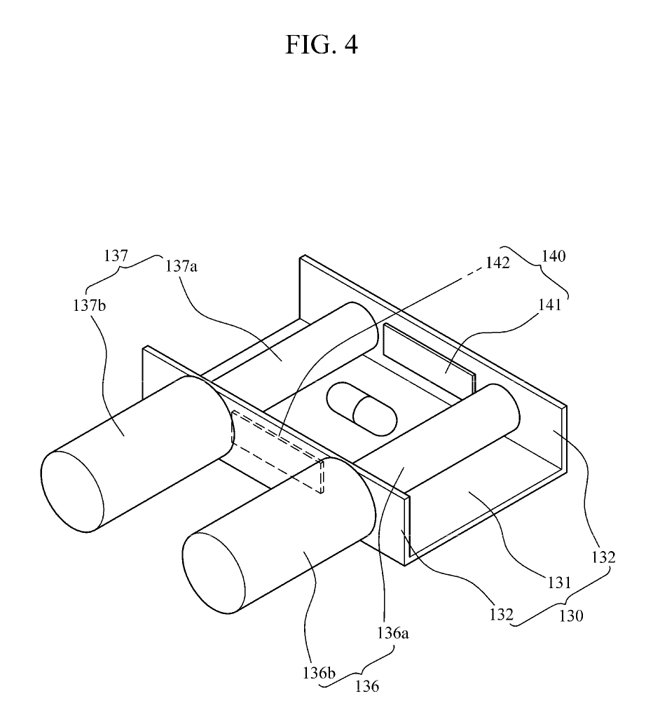

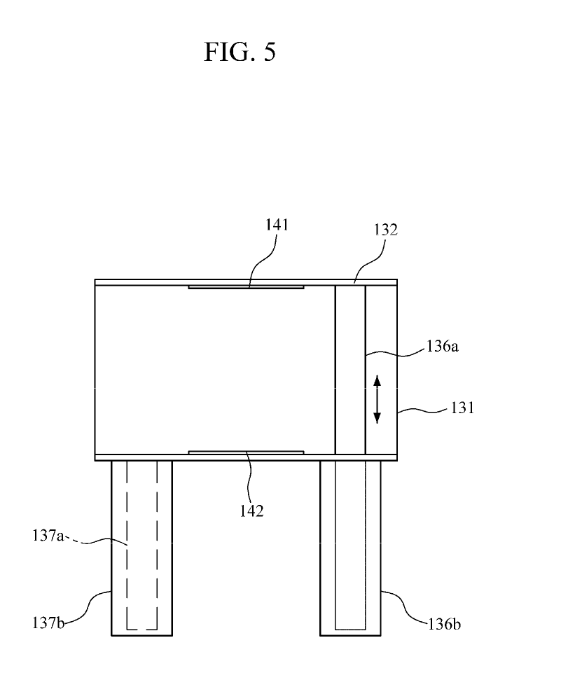

In another exemplary embodiment, as illustrated in FIGS. 4 and 5, a shooter 130 may include a first stopper 136 installed therein. The first stopper 136 is installed by an exit of the shooter 130 to open and close the exit of the shooter 130. The first stopper 136 may shut the exit of the shooter 130 to prevent the atypical pill from being discharged from the shooter 130 while a pill detector 140 is detecting an atypical pill provided to the inside of the shooter 130. Thus, the atypical pill may be more precisely detected by the pill detector 140. If the detection of the atypical pill is completed by the pill detector 140, the first stopper 136 may open the exit of the shooter 130 to allow the atypical pill to be discharged from the shooter 130.

The first stopper 136 may include a first opening and closing member 136a, and a first opening and closing member driver 136b that linearly moves the first opening and closing member 136a to open and close the exit of the shooter 130. The first opening and closing member driver 136b may be composed of a linear driver using solenoid to linearly move the first opening and closing member 136a. Moreover, the first opening and closing member driver 136b may be composed of various linear drivers, to which an exemplary embodiment is not limited.

The shooter 130 may include a second stopper 137 installed therein. The second stopper 137 is installed by an entrance of the shooter 130 to open and close the entrance of the shooter 130, with the pill detector 140 interposed between the first stopper 136 and the second stopper 137. The second stopper 137 may close the entrance of the shooter 130 to prevent the following atypical pill provided to a detection region from being entered while a pill detector 140 is detecting the atypical pill provided to the inside of the shooter 130. Thus, the atypical pill may be more precisely detected by the pill detector 140. If the detection of the atypical pill is completed by the pill detector 140, the second stopper 137 may open the entrance of the shooter 130 to allow the following atypical pill to be entered.

The second stopper 137 may include a second opening and closing member 137a, and a second opening and closing member driver 137b that linearly moves the second opening and closing member 137a to open and close the entrance of the shooter 130. The second opening and closing member driver 137b may be composed of the same as the first opening and closing member driver 136b. In a case in which it is necessary that all the atypical pills contained in the pill depository 110 be discharged through the shooter 130 to contain other types of atypical pills in the pill depository 110, the first and second opening and closing members 136a and 137a may be positioned to open both the exit and the entrance of the shooter 130.

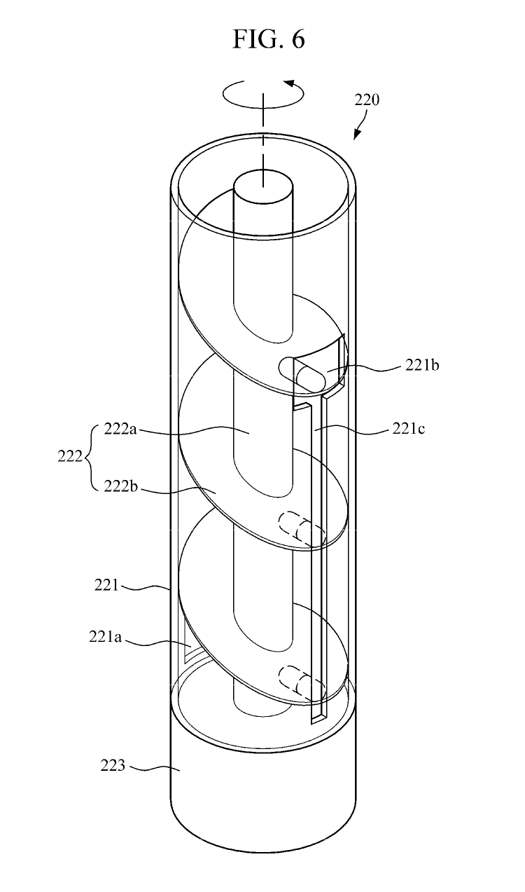

In another exemplary embodiment, as illustrated in FIG. 6, the pill transporter 220 may include a housing 221, a screw 222, and a screw driver 223. The housing 221 may be formed in a cylinder shape, which is hollow. The housing 221 may include an inlet opening 221a formed on one side to be provided with atypical pills from the pill depository 110, and a discharging opening 221b formed on the other side to discharge the atypical pills. The housing 221 may be disposed in various forms as mentioned above.

One end of the screw 222 is disposed corresponding to the side of the inlet opening 221a inside the housing 221, and the other end is disposed corresponding to the side of the discharging opening 221b. The screw 222 transports the atypical pill along a spiral when rotating. The screw 222 may include a structure where a transporting blade 222b is formed to be spiral along a circumference of a shaft 222a. Thus, if the screw 222 rotates in a state where the atypical pill is provided from the inlet opening 221a to limited space generated by the housing 221 and the transporting blade 222b, the atypical pill may be transported along the spiral by the transporting blade 222b and discharged through the discharging opening 221b of the housing 221. The screw driver 223 rotates the screw 222. The screw driver 223 may include a rotating actuator, such as a rotating motor.

The housing 221 may include an anti-slide element 221c that is formed to smoothly transport the atypical pill along the spiral. The anti-slide element 221c may be formed in a narrow crevice along a longitudinal direction of the housing 221. As a part of the atypical pill is inserted to the anti-slide element 221c during a process of moving the atypical pill upward by the transporting blade 222b, the anti-slide element 221c prevents the atypical pill from sliding down due to its own weight on the transporting blade 222b. The anti-slide element 221c may be formed in a groove on an inner wall of the housing 221.

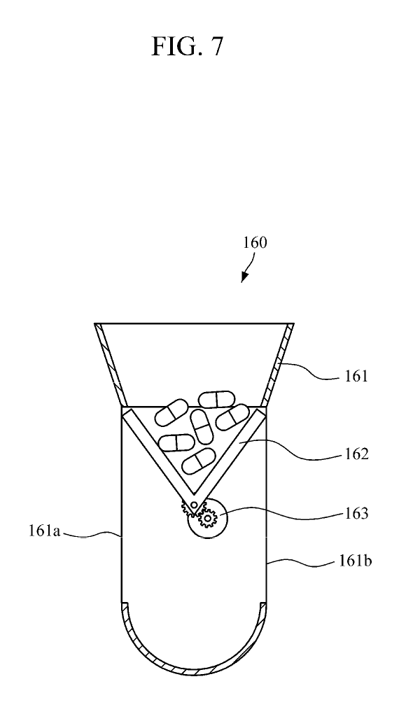

In another exemplary embodiment, as illustrated in FIG. 7, an atypical pill dispensing apparatus 100 may include a hopper unit 160 that is provided with the atypical pill discharged from a shooter 130. Here, if an amount of atypical pills provided from the shooter 130 is identical to a set amount of atypical pills, the hopper unit 160 may provide the atypical pills to a packaging unit. Otherwise, the hopper unit 160 may be configured to collect the atypical pills.

The hopper unit 160 may include a hopper member 161, a separation plate 162, and a separation plate driver 163. The hopper member 161 may have inner space and an upper portion formed to be open. The hopper member 161 may be equipped with a counting sensor (not illustrated) on the side of the upper opening. The counting sensor is placed to count the amount of the atypical pills provided to the hopper member 161 from the shooter 130. Information detected by the coefficient sensor may be provided to a controller 150. The controller 150 may determine whether the amount of atypical pills actually provided to the hopper member 161 is identical to the set amount, on the basis of the information detected by the counting sensor. The counting sensor may be composed of an optical proximity sensor, and the like.

The hopper member 161 may be formed with first and second openings 161a and 161b on both sides. The separation plate 162 may be formed to contain the atypical pills provided from the upper portion of the hopper member 161 while preventing the atypical pills from being discharged to the first or second opening 161a or 161b. The separation plate 162 may be formed in a “V” shape.

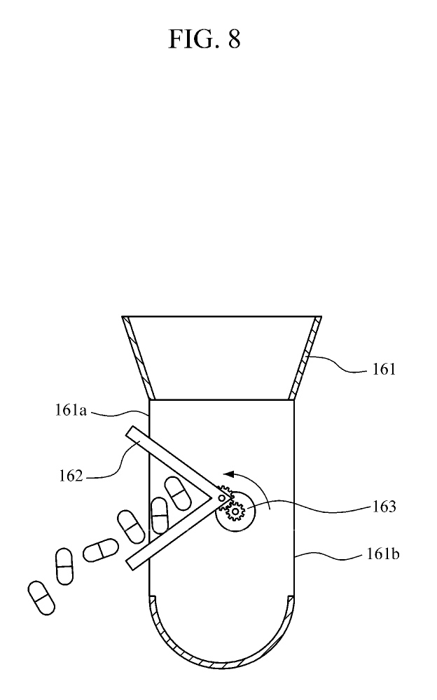

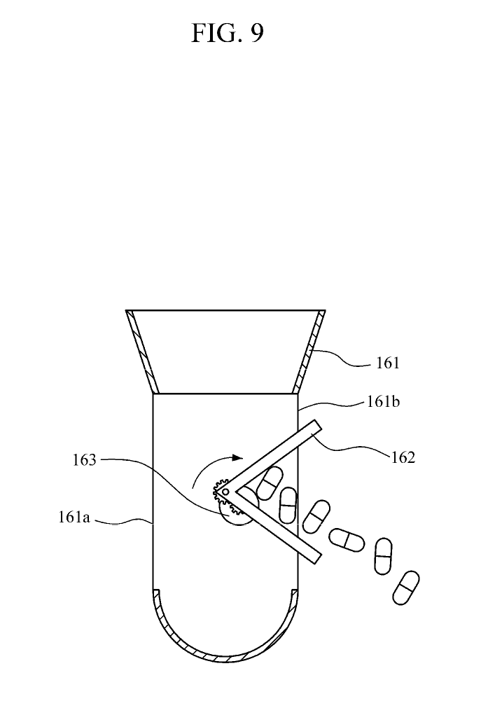

When the atypical pills are provided from the shooter 130 to the separation plate 162, in a case in which the counting sensor has determined that the amount of the atypical pills is identical to the set amount, the separation plate 162 may rotate to allow the atypical pills contained therein to be discharged by the separation plate driver 163 through the first opening 161a as illustrated in FIG. 8. Otherwise, in a case in which the coefficient sensor has determined that the amount of the atypical pills is not identical to the set amount, the separation plate 162 may rotate to allow the atypical pills contained therein to be discharged by the separation plate driver 163 through the second opening 161b as illustrated in FIG. 9. The atypical pills discharged through the second opening 161b may be collected after being contained in a pill collecting container. The separation plate driver 163 may be composed of a rotating motor, and gears that transfers the rotatory power of the rotating motor to the separation plate 162. The separation plate driver 163 may be provided in various ways within a range of rotating the separation plate 162.

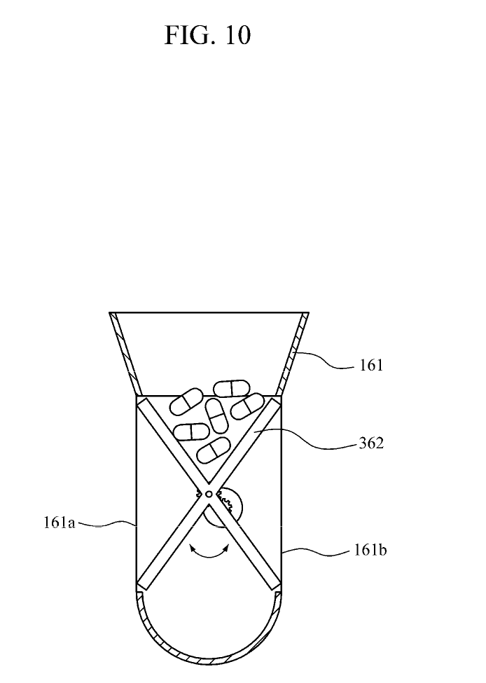

In another exemplary embodiment, the separation plate 162 may be provided in an “X” form as illustrated in FIG. 10. In addition, the hopper unit 160 may definitely be structured in various forms within a range where the above-mentioned functions are performed.

A number of examples have been described above. Nevertheless, it should be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An atypical pill dispensing apparatus, comprising:
a pill depository configured to contain atypical pills;
a pill transporter comprising:
a housing comprising an inlet opening formed on one side to be provided with the atypical pills from the pill depository, and a discharging opening formed on the other side to discharge the atypical pills;
a screw with one end disposed corresponding to the inlet opening and the other end disposed corresponding to the discharging opening so as to transport the atypical pills along a spiral when rotating; and
a screw driver configured to rotate the screw; and
a controller configured to enable the pill transporter to control a transportation of the atypical pills.

2. The atypical pill dispensing apparatus of claim 1, further comprising:
a shooter configured to be provided with the atypical pills transported by the pill transporter, and drop the atypical pills at an angle; and
a pill detector installed in the shooter so as to detect information on the atypical pills entering the shooter and provide the information to the controller.

3. The atypical pill dispensing apparatus of claim 2, further comprising:
a first stopper installed by an exit of the shooter so as to open and close the exit of the shooter.

4. The atypical pill dispensing apparatus of claim 3, further comprising:
a second stopper installed by an entrance of the shooter with the pill detector interposed between the first stopper and the second stopper so as to open and close the entrance of the shooter.

5. The atypical pill dispensing apparatus of claim 2, further comprising:
a hopper unit configured to be provided with the atypical pills discharged from the shooter, and comprise:
a hopper member with first and second openings on both sides with an upper portion opened;
a separation plate configured to be selectively rotated to discharge the atypical pills to either the first or second opening in a state where the atypical pills provided from the upper portion of the hopper member are contained while the is atypical pills are prevented from being discharged to either the first or second opening; and
a separation plate driver configured to rotate the separation plate.

6. The atypical pill dispensing apparatus of claim 1, wherein the housing comprises the discharging opening disposed at a higher position diagonally or vertically above the inlet opening.

7. An atypical pill dispensing apparatus, comprising:
a pill depository configured to contain atypical pills;
a pill transporter comprising:
a housing comprising an inlet opening formed on one side to be provided with the atypical pills from the pill depository, and a discharging opening formed on the other side to discharge the atypical pills;
a first transporting member comprising, in the housing, a first shaft with one end disposed corresponding to the inlet opening and the other end disposed corresponding to the discharging opening, and a first spiral projection protruding in a spiral form along a circumference of the first shaft;
a second transporting member comprising, in the housing, a second shaft with one end disposed corresponding to the inlet opening and the other end disposed corresponding to the discharging opening, wherein the second shaft is disposed in parallel to the first shaft, and a second spiral projection protruding in a spiral form along a circumference of the second shaft; and
a transporting member driver configured to transport the atypical pills is accommodated in limited space generated by the first and second spiral projections in response to rotation of the first and second transporting members simultaneously and symmetrically in opposing directions; and
a controller configured to enable the pill transporter to control a transportation of the atypical pills.

8. The atypical pill dispensing apparatus of claim 7, further comprising:
a shooter configured to be provided with the atypical pills transported by the pill transporter, and drop the atypical pills at an angle; and
a pill detector installed in the shooter so as to detect information on the atypical pills entering the shooter and provide the information to the controller.

9. The atypical pill dispensing apparatus of claim 8, further comprising:
a first stopper installed by an exit of the shooter so as to open and close the exit of the shooter.

10. The atypical pill dispensing apparatus of claim 9, further comprising:
a second stopper installed by an entrance of the shooter with the pill detector interposed between the first stopper and the second stopper so as to open and close the entrance of the shooter.

11. The atypical pill dispensing apparatus of claim 8, further comprising:
a hopper unit configured to be provided with the atypical pills discharged from the shooter, and comprise:
a hopper member with first and second openings on both sides with an upper portion opened;
a separation plate configured to be selectively rotated to discharge the atypical pills to either the first or second opening in a state where the atypical pills provided from the upper portion of the hopper member are contained while the atypical pills are prevented from being discharged to either the first or second opening; and
a separation plate driver configured to rotate the separation plate.

12. The atypical pill dispensing apparatus of claim 7, wherein the housing comprises the discharging opening disposed at a higher position diagonally or vertically above the inlet opening.
